(19) United States
(12) Patent Application Publication
(10) Pub. No.: US 2026/0194861 A1
(43) Pub. Date: Jul. 9, 2026

(54) METHOD AND SYSTEM FOR WASHING A TIMEPIECE STONE

(71) Applicant: LA PIERRETTE S.A., Le Brassus (CH)

(72) Inventors: Roger Oulevay, Villars-Le-Terroir (CH); Marco Pavone, Neuchâtel (CH)

(73) Assignee: LA PIERRETTE S.A., Le Brassus (CH)

(21) Appl. No.: 19/130,896

(22) PCT Filed: Nov. 16, 2023
(86) PCT No.: PCT/EP2023/082151

§ 371 Date: Jun. 10, 2025

(30) Foreign Application Priority Data
Nov. 16, 2022 (EP) 22207902.2

(51) Int. Cl. G04D 3/08; G04B 31/008; G04B 31/06

(52) U.S. Cl. CPC G04D 3/08; G04B 31/008; G04B 31/06

(57) ABSTRACT

The method for producing a timepiece component (1), in particular a pivot stone (1), having a hole (5), involves: abrasively machining the hole (5) using abrasive particles (21) that are free relative to a machining support (20), in particular diamond particles, which roll between the surface (6) of the hole to be machined and the machining support (20) accommodated in the hole, and/or using abrasive particles that can detach from the machining support, followed by washing the timepiece component (1) and the machining support (20) while the machining support is accommodated in the hole, and then removing the machining support from the hole.

The invention relates to a pivot jewel for a timepiece movement. The invention relates to a process for producing such a pivot jewel and to a machine for polishing such a pivot jewel. The invention also relates to a process for determining the roughness of a surface of a pivot hole of such a pivot jewel. The invention also relates to a timepiece component comprising such a pivot jewel. The invention also relates to a timepiece movement comprising such a pivot jewel or such a timepiece component. The invention lastly relates to a timepiece comprising such a timepiece movement or such a pivot jewel or such a timepiece component.

The invention also generally relates to a process for producing a component comprising a hole. The invention also relates to:
such a timepiece component,
a timepiece movement comprising such a timepiece component, and
a timepiece comprising such a timepiece movement or such a timepiece component.

Timepiece jewels are key elements for the good functioning of a timepiece movement. Almost all the rotational movements are performed by staffs that pivot in bearings, which are produced in drilled ruby elements, also referred to as functional jewels or pivot jewels.

To produce a pivot jewel, it is known practice to size a boule of material, notably a boule of synthetic ruby, more particularly a boule of monocrystalline synthetic ruby, by sawing or wire cutting or laser cutting into plates of a given thickness. These plates are then cut to form blanks (preparations) of the jewels which are given a cylindrical outer shape, for example by a turning operation.

The jewels are then drilled, for example by a laser or by a spindle, so as to obtain a rough pivot hole. The jewels are then subjected to a step of enlarging that makes it possible to achieve the final diameter and desired surface finish of the pivot hole. A step of turning thereafter makes it possible to give the jewel its nominal outside diameter. An optional recessing operation makes it possible to form a recess on one or two face(s) of the jewel to be used as an oil sink for lubrication. Finally, polishing brings the thickness of the jewel to its final dimension and the desired surface finish. A possible final polishing makes it possible to obtain a desired outer surface finish. This polishing does not modify the surface finish of the pivot hole.

The step of enlarging is crucial because it determines not only the dimension but also the surface finish of the pivot hole. To this end, the jewels are threaded onto a wire and secured together, making it possible both to make them rotate about the axis of the pivot holes and to treat them in batches. The wire is generally conical, with a diameter that increases gradually up to the target final diameter. The addition of an abrasive and a back-and-forth movement of the wire cause the hole to be gradually enlarged until it reaches its final dimension. The rotational speed of the jewels is considerably slower than the translational speed of the wire, and the machining is largely done by the back-and-forth movement of the wire. Any residual machining striations are therefore inevitably oriented along the axis of the pivot jewel or the pivot hole, with a possible inclination of the striations by a few degrees with respect to that axis, given the rotational speed and movement rate of the wire with respect to the jewels. The equipment used and the very principle of the enlarging process do not make it possible to obtain a different orientation of the residual machining striations.

For some pivot jewels, it is desirable to obtain an olive-cut hole, i.e. a non-cylindrical hole having a convex rounded profile that decreases the diameter of the hole toward its center. Such an olive-cut hole decreases the surface area against which the staffs can rub against the pivots and makes lubrication easier. To obtain an olive-cut hole, the jewels are again threaded onto a wire and are then subjected to a particular olive-cutting process described below. Jewels which have a straight or cylindrical hole are not olive-cut and are not subjected to any process except for the enlarging described above.

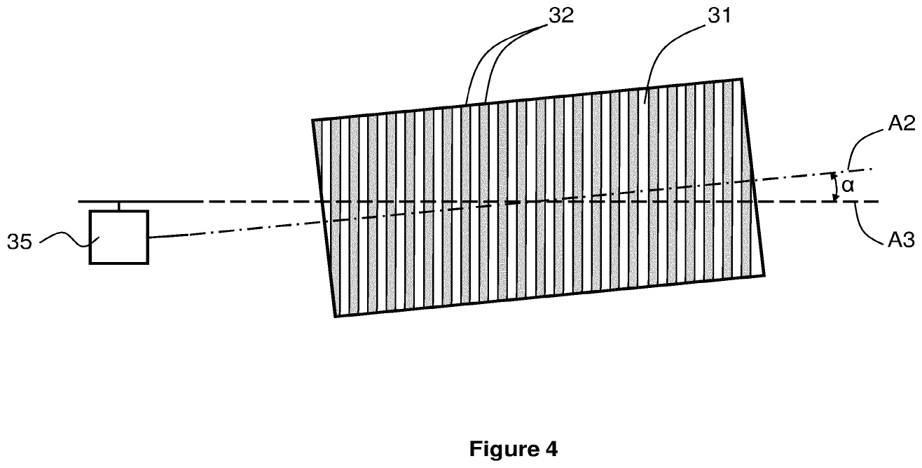

The article “La pierre d'horlogerie” [Timepiece jewels] by Pierhor S. A., published in the Société Suisse de Chronométrie [Swiss Society for Chronometry] Bulletin no. 69(June 2012), describes the main steps of the processes for manufacturing various jewels, and also the various types of jewel. The olive-cutting process is illustrated in FIG. 4 of that article. The operation is performed on machines by inclining the jewels on a roller provided with a helical groove, by means of a wire which has a precise diameter and is coated with a diamond suspension. The jewel is driven along the roller via the groove and the wire abrades the ends of the pivot hole. A good choice of parameters makes it possible to reverse the direction of inclination of the jewel in the middle of the roller and thus obtain a olive cut which is as even and symmetrical as possible.

Documents CH121766 and CH336311 describe machines for producing jewels, with a wire coated with a mixture of oil and diamond powder, either for reaming/enlarging by way of a back-and-forth movement in the axial direction, or for olive cutting with an inclination of the jewel.

Document CH706268 emphasizes the effect of the olive cutting of jewels, which makes it possible to reduce friction.

Document CH393194 describes a process for manufacturing jewels which makes it possible to obtain a very low surface roughness, followed by a treatment of the areas of friction to obtain a topography/roughness suitable for holding the lubricant by intentionally producing small holes, grooves, roughness or undulations. These unevennesses have an order of magnitude of several molecules of the lubricant used, i.e. a fraction of a micrometer according to the applicant. However, the document does not cite any values or quantitative elements and does not mention a specific process for obtaining the surface finish in question.

Document EP2778801 describes a sintered jewel with a hole formed by a laser, and then finishing by lapping, brushing and/or polishing to locally modify the roughness, without providing further detail.

Documents EP3835881 and EP3835882 also relate to various aspects of a process for manufacturing polycrystalline jewels by pressing. These jewels have the particular feature of comprising a flared hole, the smallest diameter of which can be less than 0.11 mm. The aim of the process in this case is to provide an alternative to the processes making use of a laser which, according to the applicant, would not make it possible to directly obtain a high-quality surface finish. Producing the jewel by pressing would make it possible to obtain a good surface finish, whereas drilling the jewel using a femtosecond laser would give it an unsatisfactory surface finish.

The aim of the invention is to provide a pivot jewel which performs well and makes it possible to improve the known pivot jewels of the prior art. In particular, the invention proposes a pivot jewel which has improved pivoting characteristics, in particular improved roughness characteristics, and processes associated with such a jewel.

According to a first aspect, the invention is defined by the following propositions.
1. A pivot jewel (1) for a timepiece movement (100), the pivot jewel (1) comprising a pivot hole (5) having a first axis (A1) and capable of pivoting a timepiece component (98) or capable of pivoting about a timepiece component (98), such as a timepiece staff, the pivot hole comprising a surface (6) which has main abrasive-machining striations (61), notably main polishing striations, oriented substantially orthoradially with respect to the first axis (A1).
2. The pivot jewel (1) according to proposition 1, characterized in that the main machining striations (61) have a helix angle less than 1° or less than 0.5°.
3. The pivot jewel (1) according to proposition 1 or 2, characterized in that the main machining striations (61) are parallel or substantially parallel to a plane perpendicular to the first axis (A1) and/or form an angle less than 1° or less than 0.5° with respect to a plane perpendicular to the first axis (A1).
4. The pivot jewel (1) according to one of propositions 1 to 3, characterized in that the main machining striations (61) have an orientation dispersion of plus or minus θ, where θ>0.2°, in particular where θ is about 0.5°, about a mean orientation.
5. The pivot jewel (1) according to one of propositions 1 to 4, characterized in that the roughness Ra of the surface, notably the roughness Ra of the surface (6) measured parallel to the first axis (A1) or perpendicularly to the main striations (61), is less than 20 nm or less than 10 nm or less than 5 nm.
6. The pivot jewel (1) according to one of propositions 1 to 5, characterized in that the diameter of the pivot hole (5) is less than 2.5 mm or less than 2 mm or less than 1.6 mm or less than 0.6 mm or less than 0.3 mm.
7. The pivot jewel (1) according to one of propositions 1 to 6, characterized in that the profile of the surface (6) of the pivot hole (5), through a plane passing through the first axis (A1), is straight or cylindrical.
8. The pivot jewel (1) according to one of propositions 1 to 6, characterized in that the profile of the surface (6) of the pivot hole (5), through a plane passing through the first axis (A1), is convex as seen from the first axis (A1) with a deflection of less than 1 μm or less than 0.5 μm or less than 0.25 μm.
9. The pivot jewel (1) according to one of propositions 1 to 8, characterized in that it is made of a technical ceramic, notably of ruby.
10. The pivot jewel (1) according to one of propositions 1 to 9, characterized in that it comprises a rolling surface (7), notably a rolling surface (7) of first axis (A1), intended to roll on a timepiece component.
11. The pivot jewel (1) according to one of propositions 1 to 10, characterized in that the geometries and/or positionings of the main striations are not controlled.
12. The pivot jewel (1) according to one of propositions 1 to 11, characterized in that the surface (6) exhibits an isotropy:
strictly greater than 0, in particular greater than 1%, and
less than 10%, in particular less than 3%.
13. A timepiece component (98), notably a wheel (98), in particular a center wheel, comprising at least one pivot jewel according to one of propositions 1 to 12, in particular at least two pivot jewels according to one of propositions 1 to 12.
14. A timepiece movement (100) comprising at least one pivot jewel according to one of propositions 1 to 12, in particular at least two pivot jewels according to one of propositions 1 to 12, and/or comprising a timepiece component (100) according to proposition 13.
15. The timepiece movement (100) according to proposition 14, characterized in that the at least one jewel pivots a timepiece component, said timepiece component being:
a balance, or
a pallet set, or
an escape wheel.
16. The timepiece movement (100) according to proposition 14, characterized in that the at least one jewel pivots a timepiece component which is a wheel of a finishing gear, such as:
a minutes wheel, or
a third wheel, or
a seconds wheel.
17. The timepiece movement (100) according to proposition 14, characterized in that the at least one jewel pivots a timepiece component which is a wheel of an automatic winding drivetrain.
18. A timepiece (200), notably a wristwatch, comprising:
at least one pivot jewel (1) according to one of propositions 1 to 12, and/or
a timepiece component (98) according to proposition 13, and/or
a timepiece movement (100) according to one of propositions 14 to 17.

According to a second aspect, the invention is defined by the following propositions.
19. A process for producing a pivot jewel (1) for a timepiece movement (100), the pivot jewel (1) comprising a pivot hole (5) having a first axis (A1), notably a straight or cylindrical pivot hole having a first axis (A1), and capable of pivoting a timepiece component (98), such as a timepiece staff, or capable of pivoting about a timepiece component (98), the process comprising a first step of polishing, in which:
(i) use is made of free abrasive particles (21), notably diamond particles, rolling between the surface (6) of the pivot hole (5) to be polished and a polishing support (20), such as a wire (20), and/or
(ii) the pivot jewel (1) is driven in a rotational movement about the first axis (A1) relative to a polishing support (20) drawn back toward the surface (6) of the pivot hole (5) to be polished.
20. The production process according to proposition 19, characterized in that, during the first step of polishing, the pivot jewel (1) is held in position relative to the polishing support (20) by contact with its peripheral face (7).
21. The production process according to either of propositions 19 and 20, characterized:
in that the first axis (A1) is parallel or substantially parallel to a surface of the polishing support (20), and/or
in that the first axis (A1) is parallel or substantially parallel to a second axis (A3) of the polishing support (20), the polishing support consisting notably of a wire (20).
22. The production process according to one of propositions 19 to 21, characterized in that, during the first step of polishing, the pivot jewel (1) is driven relative to the polishing support (20) by contact with its peripheral face (7).
23. The production process according to one of propositions 19 to 22, characterized in that, during the first step of polishing, the pivot jewel (1) is driven in a straight helical or rotational movement about the first axis (A1) relative to the polishing support (20).
24. The production process according to one of propositions 19 to 23, characterized in that the angle between the first axis (A1) and a second axis (A3) of the polishing support is less than 0.5°.
25. The production process according to one of propositions 19 to 24, characterized in that the free abrasive particles (21) are contained in a suspension, notably a water- or oil-based suspension, covering the polishing support.
26. The production process according to one of propositions 19 to 25, characterized in that, during the first step of polishing, a clearance of between 5 μm and 20 μm, typically 10 μm, is formed between the polishing support (20) and the pivot hole (5).
27. The production process according to one of propositions 19 to 26, characterized in that the process comprises, after the first step of polishing, a second step of machining a recess (3) on one or two faces (2, 4) of the pivot jewel (1), the face(s) (2, 4) extending perpendicularly or substantially perpendicularly to the first axis (A1).
28. The production process according to one of propositions 19 to 27, characterized in that the process comprises, after the first step of polishing, a third step of polishing at least one face (2, 4), preferably two faces, of the pivot jewel (1), the face(s) (2, 4) extending perpendicularly or substantially perpendicularly to the first axis (A1).
29. The production process according to one of propositions 19 to 28, characterized in that the speed of the pivot jewel (1) in the orthoradial direction with respect to the first axis (A1) at the contact with the polishing support (20) and relative to the polishing support (20) ranges between 1 m/s and 10 m/s or between 1 m/s and 20 m/s.
30. A machine (30) for polishing pivot holes (5) of pivot jewels (1) for a timepiece movement (100), the pivot jewels (1) having pivot holes oriented along a first axis (A1), the machine comprising a drum (31) rotationally driven about a second axis (A2) and having a slot (32) that forms a helix around the drum (31) for driving the pivot jewels and for holding the pivot jewels in a position such that the first axis (A1) is perpendicular to the osculating plane of the helix at the contact between the pivot jewel and the slot.
31. The polishing machine according to proposition 30, characterized in that it comprises a polishing support (20) having a second axis (A3) and in that:
the second axis (A3) of the polishing support and/or the first axis (A1) of the pivot holes is perpendicular to the tangent to the helix of the slot, and/or
the second axis (A3) of the polishing support and/or the first axis (A1) of the pivot holes is perpendicular to the osculating plane of the helix of the slot at the contact between the pivot jewel and the slot (32).
32. The polishing machine according to proposition 30 or 31, characterized in that the helix around the drum (31) has a helix angle less than 0.1° or less than 0.05°.
33. The polishing machine according to one of propositions 30 to 32, characterized in that the machine comprises a polishing support (20) in wire form intended to hold the pivot jewels at the bottom of the slot (32) and to polish the pivot holes (5) by abrasion.
34. The polishing machine according to one of propositions 30 to 33, characterized in that the machine comprises an element (35) for setting the orientation of the polishing support (20) relative to the second axis (A2).
35. The polishing machine according to one of propositions 30 to 34, characterized in that the machine comprises a clamp (33) for distributing the pivot jewels (1), the clamp being arranged to feed the drum (31) by bringing the pivot jewels to the drum one at a time.
36. The polishing machine according to one of propositions 30 to 35, characterized in that the diameter of the drum (31) is greater than 10 cm and/or in that the profile of the slot is U-shaped or rectangular, notably without a chamfer at the bottom of the slot, to make it easier to hold the pivot jewels in their vertical position with respect to the drum (31) properly.
37. The polishing machine according to one of propositions 30 to 36, characterized in that it comprises a feed element (38) for depositing a suspension containing free abrasive particles (21) onto the polishing support (20).

According to a third aspect, the invention is defined by the following propositions.
38. A process for producing a timepiece component (1), in particular a pivot jewel (1), comprising a hole (5), the process comprising:
a step of machining the hole (5) by abrasion using abrasive particles (21), notably diamond particles, which are free in relation to a machining support (20) and roll between the surface (6) of the hole to be machined and the machining support (20) accommodated in the hole, and/or using abrasive particles that are able to break off from the machining support, then
a step of washing the timepiece component (1) and the machining support (20) while the machining support is accommodated in the hole, and then
a step of removing the machining support from the hole.
39. The production process according to proposition 38, characterized in that the step of washing comprises the use of a washing solution, notably an aqueous solution or an alcoholic solution or an oily solution.
40. The production process according to proposition 39, characterized in that the step of washing includes immersing the timepiece component (1) and the machining support (20) in the washing solution.
41. The production process according to proposition 40, characterized in that the immersing includes emitting ultrasound into the washing solution.
42. The production process according to one of propositions 38 to 41, characterized in that the step of washing includes spraying a washing solution onto the timepiece component (1) and the machining support (20).
43. The production process according to one of propositions 38 to 42, characterized in that the step of washing includes blowing a gas or steam.
44. The production process according to one of propositions 38 to 43, characterized in that the step of washing is carried out on a machining machine, notably on a polishing machine on which the step of machining the hole by abrasion was carried out.
45. The production process according to one of propositions 38 to 43, characterized in that the step of washing is carried out after removal of the assembly made up of:
the timepiece component (1), and
the machining support (20)
   from a machining machine on which the step of machining the hole by abrasion was carried out.
46. The production process according to one of propositions 38 to 45, characterized in that the step of washing is implemented in a housing (80), the assembly made up of the timepiece component (1) and the machining support (20) passing all the way through the housing.
47. A washing system (84) comprising hardware means (80, 81, 82, 83) for implementing the step of washing a timepiece component (1) while a machining support is accommodated in a hole of a timepiece component (1) by the process according to one of propositions 38 to 46, notably:
a housing (80), for example formed overall by two parts (81, 82) which are movable with respect to one another and/or have a passage for the machining support, and
nozzles 83 and/or channels for spraying the washing solution.
48. A machining system (30) comprising hardware means (20, 31, 34, 35, 36, 37, 38, 39, 40, 84) for implementing the process according to one of propositions 38 to 46, notably comprising a washing system (84) according to proposition 47.
49. A timepiece component (1), notably a pivot jewel (1), obtained by implementing the process according to one of propositions 38 to 46.
50. A timepiece movement (100) comprising a timepiece component (1) according to proposition 49.
51. A timepiece (200) comprising a timepiece component according to proposition 49 and/or a timepiece movement (100) according to proposition 50.

According to a fourth aspect, the invention is defined by the following propositions.
52. A process for determining the roughness of a surface (6) of a pivot hole (5) of a pivot jewel (1) for a timepiece movement (100), the process comprising:
a first step of preparing the pivot jewel (1), comprising ablating a first part of the pivot jewel (1) including (i) a part of the surface (6) of the pivot hole (5), (ii) a part of an outer surface (7) of the pivot jewel (1) and (iii) a part of the volume between the surface (6) of the pivot hole and the outer surface (7) in order to obtain a second part of the pivot jewel (1), and then
a second step of measuring the surface (6) of the pivot hole (5) located on the second part of the pivot jewel (1).
53. The determination process according to proposition 52, characterized in that the ablation of the first part of the pivot jewel is performed through a plane passing through an axis (A1) of the pivot hole (5) or through a plane parallel to the axis (A1) of the pivot hole (5) and/or in that the first step of preparing does not modify the surface (6) of the pivot hole (5) located on the second part of the pivot jewel (1) but allows access thereto.
54. The determination process according to either of propositions 52 and 53, characterized in that the ablation is carried out by abrasion.
55. The determination process according to proposition 54, characterized in that a sub-step of assembling multiple pivot jewels (1) is implemented before the ablation.
56. The determination process according to one of propositions 52 to 55, characterized in that a sub-step of assembling one or more pivot jewels (1) on a support is implemented before the ablation.
57. The determination process according to proposition 55 or 56, characterized in that the sub-step of assembling includes threading pivot jewels onto a wire.
58. The determination process according to one of propositions 52 to 57, characterized in that a sub-step of coating the pivot jewel (1) or the pivot jewels (1) is implemented before the ablation.
59. The determination process according to proposition 52 or 53, characterized in that the ablation is carried out by fragmentation.
60. The determination process according to proposition 59, characterized in that a sub-step of making an incision in the pivot jewel (1) on one face (2, 4) of the pivot jewel (1) is implemented before the fragmentation.
61. The determination process according to proposition 60, characterized in that the fragmentation is carried out by applying an impact to one part of the pivot jewel (1), the other part of the pivot jewel being held on a support, the parts being delimited by the incision.
62. The determination process according to proposition 52 or 53, characterized in that the ablation is performed by saw or wire cutting.
63. The process according to one of propositions 52 to 62, characterized in that the second step of measuring is carried out by laser scanning confocal microscopy.
64. The process according to one of propositions 52 to 63, characterized in that the second step of measuring includes determining a direction perpendicular to the main machining striations (61) on the surface (6) of the pivot hole (5) of the pivot jewel (1).
65. The process according to proposition 64, characterized in that the second step of measuring is a linear measurement along the direction perpendicular to the main machining striations (61) on the surface (6) of the pivot hole (5) of the pivot jewel (1).

Unless logically or technically incompatible, all the features of these various aspects can be combined with one another.

The appended drawings show, by way of example, embodiments of pivot jewels, of polishing machines and of associated processes according to the invention.

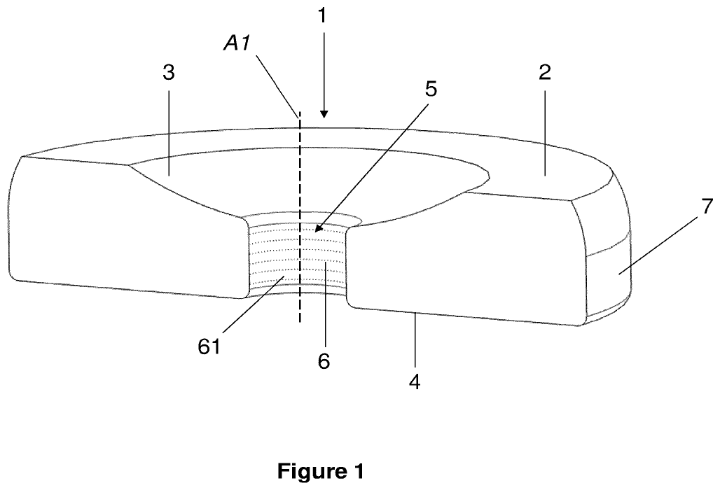

FIG. 1 is a perspective view, in longitudinal section, of one embodiment of a pivot jewel according to the invention.

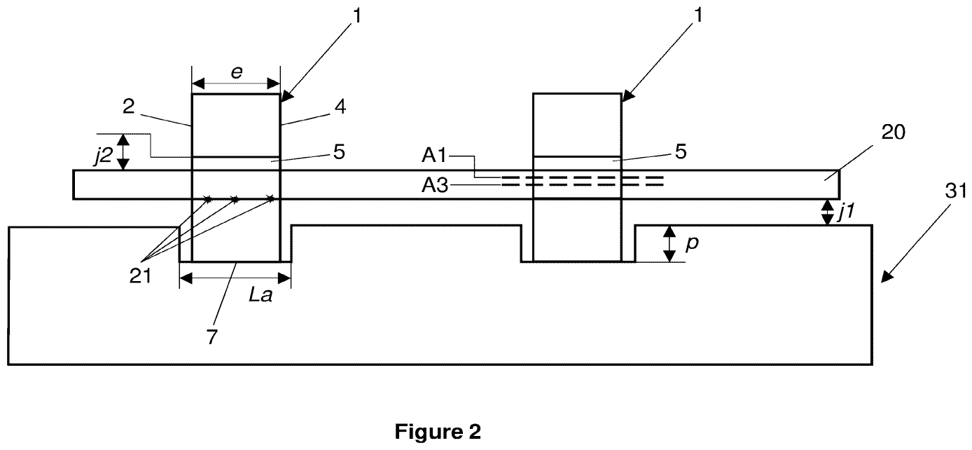

FIG. 2 is a view, in longitudinal section, of multiple pivot jewels according to the invention in the course of being polished.

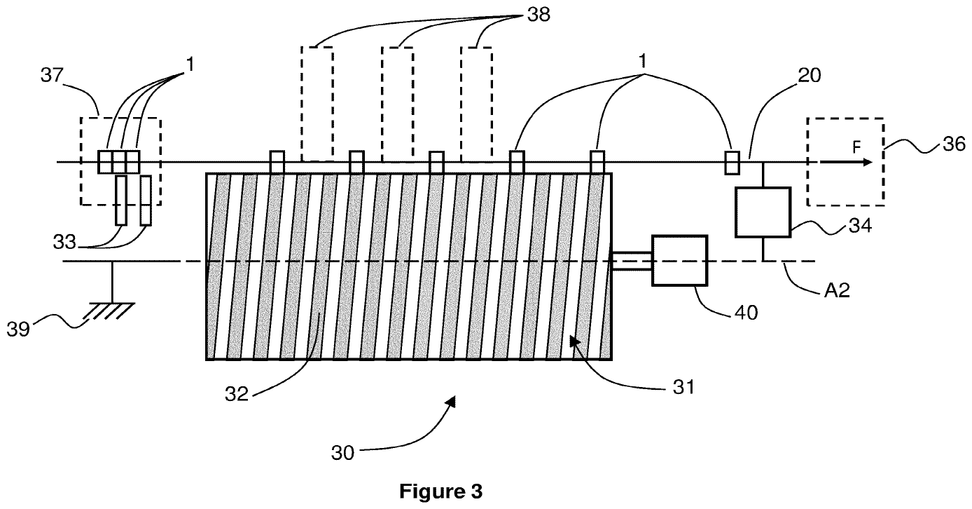

FIG. 3 is a schematic side view of one embodiment of a polishing machine according to the invention.

FIG. 4 is a schematic top view of the embodiment of the polishing machine according to the invention.

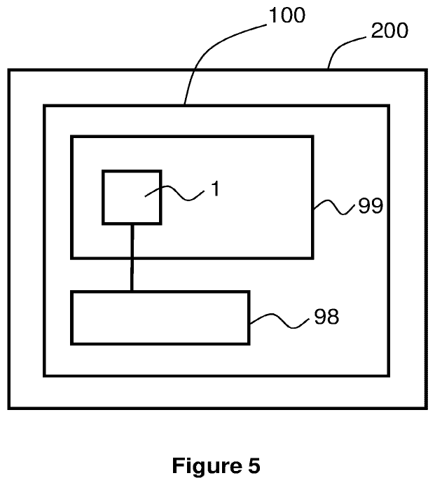

FIG. 5 is a schematic illustration of a first embodiment of a timepiece according to the invention.

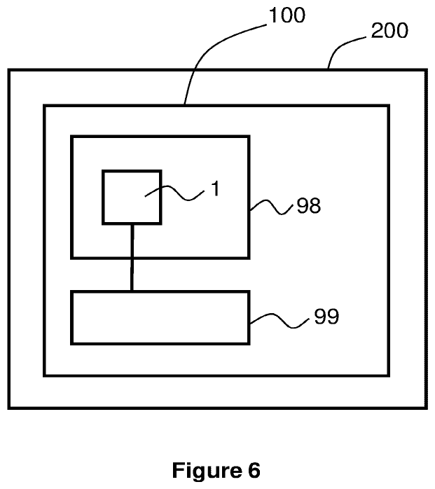

FIG. 6 is a schematic illustration of a second embodiment of a timepiece according to the invention.

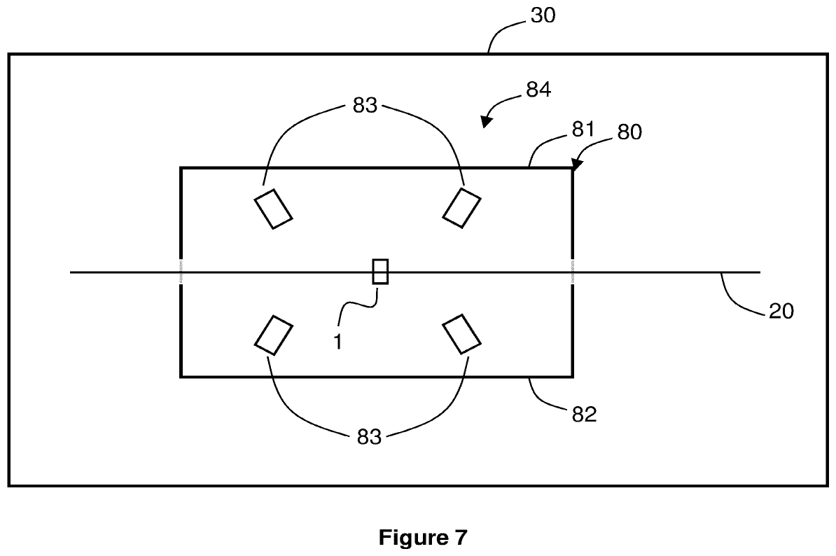

FIG. 7 is a schematic side view of one embodiment of a washing system according to the invention.

Work carried out by the applicant has demonstrated that the surface finish in the pivot areas is crucial for ensuring the reliability of the timepiece movement, in particular for ensuring that the staffs pivot reliably in the pivot jewels. The applicant has observed that it is still possible to improve the wear resistance of the pivots, notably by eliminating, or delaying the appearance of, a viscous black deposit likely to cause a drop in performance.

The developments made by the applicant have made it possible to obtain an excellent surface finish within the pivot hole of a jewel, in particular for a jewel with a straight or cylindrical hole, i.e. a hole without a conical, frustoconical or olive-cut surface. These developments relate to the method for measuring the roughness, the method for preparing the jewels in order to measure the roughness, the machine (or equipment) and the process for obtaining the optimized surface finish by polishing, the process for washing the jewels after they have been polished, and also the jewel with an optimized surface finish. In particular, the solutions provided by the invention make it possible to obtain a roughness Ra of the pivot hole of less than 10 nm with a preferential orientation of the residual polishing striations in the orthoradial direction with respect to the axis of the pivot hole. The striations are machining striations, in particular polishing striations, and their geometries and positionings on the surface of the pivot hole are largely not controlled and exceedingly random. According to the invention, all that is done is that:
the depth of the striations is roughly controlled by choosing an abrasive capable of producing depths in nanometers, for example resulting in a roughness Ra less than 20 nm, and
the orientation of the striations is roughly controlled with an orientation dispersion of plus or minus θ, where θ>0.2°, in particular where θ is about 0.5°, about a mean orientation.

As mentioned above, timepiece jewels are a key element for the reliability of the timepiece movement. The challenge is to obtain a suitable surface finish with optimum reproducibility over all of the jewels in one manufacturing batch and also from one batch to the next. This is all the more necessary since it is very difficult and destructive to check the surface finish of the pivot hole.

Numerous pivoting movements of timepiece movements are ensured and realized by jewels with straight or cylindrical holes. This is the case for example for the pivoting movements of a minutes wheel, a third wheel, a seconds wheel or a calendar wheel. In general, pivoting movements performed by a staff provided with a small-diameter pivot (sprung balance oscillator, pallets, pallet wheel) are provided by olive-cut jewels (i.e. jewels of which the pivot hole has an olive cut), whereas the staffs of larger diameter (above 0.15 mm, for example) are pivoted in straight jewels (i.e. jewels with straight holes).

The applicant has also noted that a “cottonizing” operation, performed by moving a cotton thread carrying a suspension of diamond particles back and forth, makes it possible to obtain a better surface finish. However, this process is very difficult to implement for diameters less than 0.3 mm, and cannot be applied to series production for certain critical pivot bearings of the finishing gear. Even for diameters less than 0.6 mm, this process can only be implemented manually, and it has proven to be the case that this manual polishing does not have the robustness of an industrial process and does not completely eliminate the wear phenomena.

Furthermore, the roughness measurements show that the jewels obtained by the standard enlarging process have high roughnesses with an orientation of the residual polishing striations in the axial direction (i.e. parallel to the axis of the pivot hole; this is logical in view of the back-and-forth movement imposed on the jewels with respect to the wire during the process). The aforementioned manual process makes it possible to improve the roughness but does not modify the axial orientation of the striations. To eliminate the wear phenomena, the inventors have, on the contrary, noted that it was necessary to obtain not only the lowest possible roughness, but also an orientation of the residual polishing striations in the orthoradial direction (with respect to the axis of the pivot hole), in order to minimize the effects of abrasion of the pivot jewel on the staff it is intended to receive.

One embodiment of a pivot jewel 1 for a timepiece movement 100 is shown in FIG. 1. The pivot jewel 1 has a cylindrical overall shape of axis A1 and comprises a pivot hole 5 along the axis A1. This pivot hole 5 comprises a surface 6, notably a cylindrical surface 6 or substantially cylindrical surface 6, and is intended to pivot a timepiece component, such as a timepiece staff, or is capable of pivoting about a timepiece component. Furthermore, the pivot jewel 1 is limited by:
an upper face 2 and a lower face 4 which preferably both extend perpendicularly to the axis A1, and
a cylindrical overall outer surface 7 of axis A1.

The pivot jewel can also have a recess 3 made on the upper face 2 and/or a recess made on the lower face 4. It is thus possible for the pivot jewel to not have a recess, to have a recess on one of the faces, to have a recess on each of the faces, or to have one curved face or two curved faces.

Advantageously, the diameter of the pivot hole 5 is less than 2.5 mm or less than 2 mm or less than 1.6 mm or less than 0.6 mm or less than 0.3 mm.

The Surface 6 Has Main Polishing Striations 61.

The pivot jewel 1 is preferably made of a technical ceramic, in particular a corundum or a spinel or a zirconia or of SiC or a silica, or possibly of other natural or synthetic stones such as diamond. The pivot jewel 1 may be made of polycrystalline or monocrystalline corundum, for example ruby, notably Cr-doped alumina, for example synthetic Cr-doped alumina, or even monocrystalline Cr-doped alumina. The pivot jewel 1 may also be made of a combination of alumina and zirconia.

According to the invention, the process for producing a pivot jewel 1 for a timepiece movement 100 makes it possible to obtain a surface finish inside the pivot hole 5 of the jewel, in particular on the surface 6, which has the lowest possible roughness and an orientation of the roughness, i.e. an orientation of the main striations, in the direction of the relative movement between the jewel and the timepiece component, notably the staff, that it is intended to receive. This orientation is therefore in an orthoradial direction with respect to the axis A1. It has been noted that this orientation specifically makes it possible to minimize the effects of abrasion and thus wear at the contact between the pivot jewel and the timepiece component, notably the staff.

In one embodiment of the process for producing a pivot jewel, the procedure is preferably as explained above, i.e. the following steps are carried out:
sizing the material into plates,
cutting the plates into blanks,
turning,
drilling rough pivoting holes,
possibly enlarging, and
possibly one or more recessing and polishing operations.

However, in addition or as an alternative to the step of enlarging, a step of specifically polishing the pivot hole, which is described in more detail below, is implemented. This step of polishing makes it possible to achieve the surface finish aim mentioned above.

The polishing is a three-body polishing operation as illustrated in FIG. 2. This polishing is carried out using a free abrasive 21 (notably diamond grains of a given diameter, in suspension in an aqueous or oily base) which rolls between the pivot jewel and a polishing support 20 of suitable geometry, notably a wire. The wire may be a metal wire, notably a metal wire of constant diameter. This three-body polishing makes it possible to obtain a meticulous surface finish and a low roughness, compared to two-body polishing in which the abrasive is secured to the polishing support and scuffs the surface. To obtain the desired orientation of the residual polishing striations 61, i. e avoid orientation along the axis A1, it is necessary to:
avoid back-and-forth polishing movements along the axis A1 of the pivot hole as are conventionally implemented in standard and conventional processes for obtaining straight holes, and
on the contrary preferring the rotational movements of the pivot jewel about the polishing support 20, i.e. about the axis A1.

Furthermore, to obtain an even surface finish over the entire height of the hole and a hole which remains straight and/or cylindrical (as opposed to an olive-cut hole), the pivot jewel must be kept straight with respect to the polishing support, i.e. the axis A1 must be kept parallel to the surface of the polishing support 20 and therefore the jewel must be stopped from going askew and/or the axis of the hole of the jewel must not have a non-zero angle with respect to the polishing support.

To simultaneously satisfy these various requirements, as illustrated in FIG. 2, the jewel 1 is threaded onto the polishing support 20, which is covered or charged evenly with the abrasive 21. A force applied to the polishing support 20 causes the jewel to be pressed against a roller or drum 31, which serves as contact surface for and means for rotating the jewel. During the step of polishing, the pivot jewel 1 is thus driven relative to the polishing support 20 by (rolling) contact on its peripheral face 7. To ensure proper driving and a movement in rotation at high speed, and also to prevent the jewel from tilting, a groove 32 (or slot 32) is formed on the roller with the width, depth, shape and pitch of the groove being judiciously chosen.

The width of the groove is chosen to guide the jewel well by preventing the latter from tilting, and is determined essentially by the thickness of the jewel taking into account a certain clearance. Typically, the width La of the groove is at least 50 μm greater than the nominal thickness e of the jewel, for example 80 to 100 μm greater. The depth p of the groove should allow good guidance of the jewel and good positioning of the wire above the roller, with a certain clearance j1 between the wire and the outer surface of the roller, typically a clearance of at least 200 μm, notably a clearance of between 200 and 400 μm. For example, for a jewel of diameter 1.2 mm and a hole of 0.2 mm, the depth p of the groove may be 0.12 mm. The profile of the groove preferably has a rectangular shape (U-shaped or rectangular profile in a longitudinal plane passing through the axis A2), notably a rectangular shape without softened edges or a chamfer at the bottom of the groove, for making it easier to hold the stone properly in its vertical position with respect to the roller 31.

The pitch of the groove could be zero, i.e. each jewel would be placed in an individual groove perfectly perpendicular to the axis of the roller. However, it is much more beneficial in industrial terms to produce a groove which is helical, i.e. has a non-zero pitch, as this makes it possible to move the jewel forward gradually along the roller when the latter is made to rotate. The pitch of the groove may be at least the same as the width La of the groove, for example typically 1.5 times the width La of the groove, for example 0.6 mm for a groove width of 0.4 mm. The pitch also determines the total distance the jewel covers over the roller: it is advantageous to choose the smallest possible pitch to maximize the distance over which the treatment or the polishing takes place and the time in which it happens. The diameter of the polishing support, for its part, is chosen depending on the diameter of the hole of the jewel, notably so as to leave a clearance j2 between the jewel and the polishing support 20 while still maintaining good resistance to traction and limiting the tendency of the jewel to tilt. Typically, the clearance j2 ranges between 5 μm and 20 μm and is for example 10 μm.

The axis of the polishing support must be oriented very precisely with respect to the groove. In particular, the axis of the polishing support must be perpendicular to the orientation of the groove (or as close to that as possible). It is thus necessary to precisely compensate for the angle of the helix of the slot. The setting precision required for this is <0.1°. The polishing machine or the equipment used to carry out such polishing therefore has a particular construction, with a means enabling such a precise setting. This amounts to inclining an axis A2 of the roller relative to an axis A3 of the polishing support, this axis A3 being parallel to the axis A1 of the pivot holes during polishing.

As illustrated in FIG. 4, this compensation angle, referenced α, can be determined with precision: if dr is the diameter of the roller and pa is the pitch of the slot 32, α=a tan(pa/(π×dr)). This compensation angle α corresponds to the angle of the helix of the slot 32. In other words, the axis A3 of the polishing support and the axis A1 of the pivot holes must be perpendicular to the tangent to the helix of the slot 32. As an alternative, the axis A3 of the polishing support and the axis A1 of the pivot holes must be perpendicular to the osculating plane of the helix of the slot 32 at the contact between the pivot jewel and the slot 32. This makes it possible to obtain a straight or cylindrical hole with a uniform roughness along the hole and with a substantially orthoradial orientation (with respect to the axis A1) of the main machining striations.

By way of example, for a roller diameter of 250 mm and a slot pitch of 0.6 mm, the compensation angle is 0.044°. More generally, the helix preferably has a helix angle less than 0.1° or less than 0.05°. This requires considerable setting precision. In practice, a first setting is performed on the basis of the theoretical value, and then a fine setting (to the order of one hundredth of a degree) is performed so as to eliminate any trace of the olive cut (i.e. to keep the hole as cylindrical as possible, which is to say minimize the difference in diameter between the center and the edges of the hole) on the jewel obtained.

To properly implement the process according to the invention, it is important that the axis A1 of the hole 5 of the pivot jewel 1 is parallel to the axis A3 of the polishing support, and/or that the angle between the axis A1 of the hole of the pivot jewel and the axis A3 of the polishing support is as low as possible, notably less than 0.5°. For this, it is necessary to be very precise when setting the compensation angle between the axis A3 of the polishing support and the axis A2 of the drum 31.

The process described above can on first glance resemble an olive-cutting process. This is because the polishing process according to the invention is implemented with jewels threaded on a polishing support and with a roller on which a helical groove has been machined, thereby allowing each jewel to be moved forward during the polishing. However, there are many significant differences:
The aim of olive cutting is to locally machine the hole, and notably the emerging ends of the hole, so as to obtain a rounded profile of the hole (the aim of olive cutting is to minimize the contact surface area between the staff and the pivot hole). Olive cutting is therefore a different way of machining to polishing. The amount of material removed during olive cutting is significant, the minimum diameter of the hole typically increasing by a few micrometers during olive cutting. In the case of olive cutting, the difference between the minimum diameter of the hole before and after it is olive-cut is typically 2 μm, and is even higher at the ends of the hole (the ends are determined along the axial direction of the jewel). The olive cutting thus makes it possible to bring the minimum diameter of the hole to the nominal dimension. On the contrary, in the case of the polishing process according to the invention, the diameter of the pivot hole is at its nominal value before the step of polishing implemented during the process for producing a jewel. It is estimated that the difference in diameter between (i) the surface finish before implementing the polishing process and (ii) the surface finish after implementing the process is less than 0.1 μm. In other words, the aim of the polishing process according to the invention is to reduce the peak-to-valley height of the striations produced during the drilling and/or enlarging operations by removing as much material as possible, so as to reduce the roughness, smooth out the unevennesses and also orient the roughness in the direction beneficial to the movement of the component as it pivots, guided by the pivot hole.
The angle between the polishing support and the orientation of the grooves is not compensated for but exaggerated when an olive cut is being made, with a value typically of about 5° to 10°, or even of 30°, thereby making it possible to tilt the jewels with respect to the axis of the polishing support in order to soften the edge corners of the edges of the hole and to create the rounded profile inside the hole. Precise control of the angle is not important for olive cutting.
As a result, in an olive-cutting process, the axis of the hole of the pivot jewels is not parallel to the axis of the polishing support but has a pronounced inclination, for example an angle of about 5° to 10°.
In addition, in an olive-cutting process, the intersection of the cylinder of the roller with the vertical plane comprising the polishing support forms an ellipse, which means that the jewel “rises” over the first half of the roller, and then “descends” over the second half of the roller, with its inclination switching over at the top, thereby making it possible to produce an even and symmetrical profile.
In an olive-cutting process, the groove is preferentially V-shaped instead of U-shaped or rectangular, in order to make it easier to tilt and incline the jewel.
As regards the sequence of the steps, the olive-cutting is carried out after the recess has been machined, because that makes it possible to obtain an olive cut which is directly centered with respect to the emerging ends of the hole, and it is easier to incline the jewel in the groove with a hole of smaller length. For the polishing process according to the invention, on the contrary it is easier to keep the jewel straight in the groove with a hole of greater length. The step of polishing the hole is therefore preferentially carried out before any machining of the recess and before any polishing of the upper and lower faces. The steps of recessing and polishing are therefore preferably reversed with the polishing process according to the invention compared with an olive-cutting process.

As a result of what has been described above, the process for producing a pivot jewel 1 for a timepiece movement 100 comprises a first step of polishing, in which:
(i) use is made of free abrasive particles 21 rolling between the surface 6 of the pivot hole 5 to be polished and the polishing support 20, and/or
(ii) the pivot jewel 1 is driven in a rotational movement about the axis A1 relative to the polishing support 20 which is drawn back toward the surface 6 of the pivot hole 5 to be polished. This drawing back allows an action of contact which is direct or indirect (via the abrasive particles) between the polishing support 20 and the surface 6.

Ignoring the rate of forward movement of the jewel in translation along the axis A1 relative to the polishing support, the movement of the jewel relative to the polishing support is considered to be a rotational movement about the axis A1.

As seen above, during the first step of polishing, the pivot jewel 1 is held in position relative to the polishing support 20 by the contact between the peripheral face 7 of the pivot jewel 1 and the bottom of the slot 32. With preference, the face 7 extends parallel or substantially parallel to the first axis A1.

With preference, as a result of the solutions described above, during the first step of polishing, the polishing support is a wire of which the axis A3 is substantially parallel to the axis A1, and the angle between the axis of the polishing support A3 and the axis A1 of the hole of the jewel is less than 0.5°.

With further preference, as a result of the solutions described above, during the first step of polishing:
the pivot jewel 1 is driven in a straight helical or rotational movement about the axis A1 relative to the polishing support 20, and/or
a helical movement with a helix angle of less than 0.5° is generated, and/or
the angle between the axis A1 and the axis of the polishing support A3 is less than 0.5°, and/or
the angle between the axis A1 (or the axis A3) and the axis A2 is equal to the angle of the helix of the slot 32.

One embodiment of a polishing machine for implementing the polishing process according to the invention is described below with reference to FIGS. 3 and 4. With preference, the polishing machine makes it possible to implement the polishing process industrially for large batches of jewels (several thousands, or even tens of thousands of jewels) reproducibly and repeatably. With preference, the machine makes it possible to simultaneously polish multiple jewels.

The main elements of one embodiment of the polishing machine are illustrated schematically in FIGS. 3 and 4. The polishing machine mainly comprises:
the roller 31 or drum 31,
the polishing support 20, and
a frame 39.

The polishing machine also comprises:
an actuator 40, comprising a motor, for rotating the roller relative to the frame 39 about the axis A2,
a module 38 for feeding or depositing abrasive onto the polishing support 20, making it possible to feed a polishing agent to the location of contact between the polishing support 20 and the hole 5 of the stones,
a distribution module 37 for bringing the jewels onto the roller one after another,
a module 36 for setting the tension F of the polishing support 20, and
a module 35 for setting the angle α between the axes A2 and A3, and
a module 34 for adjusting the position of the polishing support with respect to the roller in order to keep a constant distance between the polishing support and the roller over the entire length of the roller.

The tension setting module 36 makes it possible to keep the polishing support at the correct tension in order to ensure that the contact force exerted on the roller by the jewels is constant. The tension setting module 36 can be realized simply and effectively by an adjustable weight fixed at the end of the polishing support and thus exerting a calibrated tension on the polishing support.

It is also advantageous for the various jewels undergoing treatment to be distributed equidistantly over the roller, with a given spacing, to ensure a constant and comparable force for each jewel. To do this, the distribution module 37 can for example comprise clamps 33 for ensuring such a uniform distribution.

For example, the dimensions of the roller can be:
an outside diameter greater than 10 cm or of about 25 cm, and
a length of about 28 cm;
   these dimensions will need to be adjusted and/or optimized depending on the characteristics of the jewels.

The module 35 for setting the angle α between the axes A2 and A3 allows a very fine setting of the angle to ensure perpendicularity between:
the axis of the polishing support, and thus the axis of the holes of the jewels, and
the orientation of the groove where the jewel undergoing treatment is located.

In a variant, the setting module 35 thus makes it possible to ensure, via the setting of the angle α, perpendicularity between the axis A3 of the polishing support and the tangent to the helix of the slot. In another variant, the setting module 35 makes it possible to ensure, via the setting of the angle α, perpendicularity between the axis A3 of the polishing support and the osculating plane of the helix of the slot at the contact between the pivot jewel and the slot 32. Specifically, the setting module 35 comprises a plate which bears the roller 31 and the actuator 40 and which is settable with respect to the frame 39 which bears the polishing support 20. The setting module 35 also comprises a rolling coupling which allows the angle α to be adjusted with a precision of about 1/100°, or even < 1/100°. This adjustment is performed for example by a mechanical sliding system, which is also part of the setting module 35.

The angle α is initially set to the theoretical value, notably to the theoretical value of the angle of the helix, and then the setting jewels are produced. The angle is then adjusted if the pivot hole of the jewels produced is not cylindrical, and/or if a variation in diameter is detected along the pivot holes of the jewels produced, and/or if the presence of a deflection is detected (for example a deflection greater than 0.5 μm) along the pivot holes of the jewels produced, and/or if a significant part of the surface of the pivot hole of the jewels produced is not modified (polished) by the process. The aim is to remove the zones and traces of the drilling or enlarging operation over the entire length of the pivot hole. When the axis A1 of the hole of the jewel is parallel to the polishing support, all of the surface 6 of the hole, from the lower face 4 to the upper face 2 of the jewel, is polished uniformly or substantially polished uniformly.

To adjust the polishing support with respect to the roller, it is important for the polishing support to be in contact with the hole of the jewels. It is not necessary to precisely set the position of the polishing support, notably the angle of the axis of the polishing support with respect to the surface of the roller, given that the polishing support is guided by the jewels and kept in position by the tension applied to the polishing support. The depth of the groove does not need to be so great as to keep the polishing support away from the roller, but needs to be sufficient to ensure proper guidance of the jewel and avoid vibrations. The important thing is that the jewel is properly kept in abutment against the bottom of the groove with the force exerted by the polishing support also permitting the uniform polishing.

For example, the speed of the roller ranges between 800 and 1500 rpm and is typically 1200 rpm. With a roller diameter of about 25 cm and a jewel diameter of typically 1 mm, the result is a very high rotational speed of the jewel, of about 300 000 rpm or 5000 rps (assuming that the jewel does not slide on the roller). The rotational speed is therefore much higher than the rate at which the jewel moves forward on the polishing support: at the hole, for a hole diameter of 0.2 mm for example, the speed at the point of contact between the polishing support and the hole is 3.15 m/s in the orthoradial direction with respect to the axis A1, versus 9.2 mm/s in the axial direction with respect to the axis A1, i. e more than 300 times higher. The angle of the polishing striations relative to the plane perpendicular to the axis A1 is in this case about 0.2°, which is negligible.

The speed of the pivot jewel 1 at the contact with the polishing support 20 and in the orthoradial direction with respect to the axis A1 relative to the polishing support 20 may range between 1 m/s and 20 m/s, in particular between 1 m/s and 10 m/s.

Another advantageous element for the repeatability of the polishing process according to the invention is to ensure a good separation of the jewels on the roller, by avoiding the jewels coming against one another during the treatment, with a constant spacing from one jewel to the next. This makes it possible to ensure a contact force which is equal from one jewel to the next and along the roller. One solution for ensuring a good distribution is the use, in the distribution module 37, of precision gripping means, notably clamps, which take up exactly one jewel at a time and at identical intervals and then release the jewels in the same way onto the polishing support and the roller. The polishing support moves forward at a very low rate along the axis A1 relative to the roller so as to make the jewels move forward up to the distribution module. The rate of forward movement is typically about the thickness of a jewel per distribution period. If the module is set for a distribution of a jewel every 6 seconds onto the roller, and if the thickness of the jewel is 0.315 mm, the resulting rate of forward movement of the polishing support is typically about 0.2 m/h. The rate of forward movement is not relevant to the structure of the pivot jewel obtained by the production process. This movement is only necessary to obtain a progression of the pivot jewel outside of the roller 31 in the described embodiment of the production process.

A reliable distribution module, which ensures the correct forward movement of the polishing support and the proper distribution of the jewels, is an advantageous element in order that each jewel has the required surface finish in the pivot hole. The implementation of the process must be robust and repeatable because checking the surface finish is destructive as is and therefore is difficult to carry out or cannot be carried out as a matter of routine on jewels or on a sample of jewels during the process for manufacturing the jewels.

It goes without saying that, to ensure the proper execution of the process, it is possible to add cameras (to check for example the height of the polishing support, the position of the clamps and/or the proper distribution of the jewels on the roller), display monitors, measurement means and results, a parameter tracking means, a man/machine interface, etc.

When the polishing process is being implemented for a new jewel geometry, steps of setting and optimizing may be carried out. Generally speaking, there is a reciprocal interaction and influence to be optimized between the speed of the roller, the tension of the polishing support (and thus the force applied), the diameter of the hole, and the size of the abrasive.

More generally, a polishing machine 30 for polishing pivot holes 5 of pivot jewels 1 for a timepiece movement 100 according to the invention comprises the drum 31 driven in rotation about the axis A2 and having the slot 32 which forms a helix around the drum 31, the slot 32 both
driving the pivot jewels, and
holding the pivot jewels in a position such that the axis A1 is perpendicular to the osculating plane of the helix at the contact between the pivot jewel and the slot.

The polishing process, one embodiment of which has been described above, makes it possible on the one hand to orient the polishing scratches or striations on the surface of the pivot hole orthoradially with respect to the axis A1 of the pivot hole 5. This orientation is much more favorable because it matches the orientation of the movement of the component, notably of the pivot, that is guided in the jewel, relative to the jewel, and thus avoids a “file” effect which causes more rapid wear of the pivot. On the other hand, the polishing process, one embodiment of which has been described above, makes it possible to repeatably obtain low roughnesses with values which can be less than 5 nm for optimized conditions. As the orientation of the scratches is orthoradial with respect to the axis A1, a measurement of the roughness in the orthoradial direction is not relevant, and the values given are measured in the axial direction.

The process described above can also be applied to pivot jewels produced by other processes or process steps, such as jewels produced by pressing, and/or having a recess made by laser machining, and/or having other elements such as a clearance zone as described in the document WO2021032552A1. The process above can also be applied to other timepiece components comprising a hole, notably a cylindrical hole, such as a tube, for example a ceramic tube or a metal tube, or a timepiece component such as a cannon pinion.

More generally than what has been described above, a process for producing a timepiece component 1 may comprise a step of polishing or machining the hole 5 by abrasion using abrasive particles 21 which are free in relation to the machining support 20 and roll between the surface 6 of the hole to be machined and the machining support 20 accommodated in the hole, and/or using abrasive particles that are able to break off from the machining support, the component being driven in a rotational movement about the axis of the hole relative to the polishing or machining support.

As a result of implementing the process described above and/or the use of the machine described above, it is possible to produce a pivot jewel 1 for a timepiece movement 100, comprising a pivot hole 5, notably a cylindrical pivot hole, having a first axis A1 and capable of pivoting a timepiece component or capable of pivoting about a timepiece component. The pivot hole comprises a surface 6 which has main abrasive-machining striations 61, notably main polishing striations, which are oriented substantially orthoradially with respect to the first axis A1.

The orientation of a striation is the orientation of its length or of its greatest dimension, and may be determined by examining an image, or even by using procedures for determining the surface texture as described above. With the machining process described, neither the number nor the geometry nor the location of the machining striations is controlled, but the process results in a preferential orientation which is substantially orthoradial with respect to the axis A1 of the hole.

The main machining and/or polishing striations 61 advantageously have a mean helix angle less than 1° or less than 0.5° or, more generally, are such that:
the osculating plane with respect to any main striation at any point of this main striation, and
a plane perpendicular to the axis A1,
   are parallel or form an angle less than 1° or less than 0.5° between them.

Expressed differently, the main machining and/or polishing striations 61 are preferably parallel or substantially parallel to the plane perpendicular to the axis A1. Expressed differently again, the main machining and/or polishing striations 61 (or their tangents) form an angle less than 1° or less than 0.5° relative to the plane perpendicular to the axis A1.

Advantageously, the roughness Ra of the surface 6, notably the roughness Ra of the surface 6 measured parallel to the first axis A1 or perpendicularly to the main striations 61, is less than 20 nm or less than 10 nm.

As a result of the implementation of the process described above and/or the use of the machine described above, the profile of the surface 6 of the pivot hole 5, through a plane passing through the axis A1, can be:
straight, or
convex as seen from the axis A1 with a deflection less than 1 μm or less than 0.25 μm.

According to a first use, as illustrated in FIG. 5, the pivot jewel 1 is intended to:
be driven into a frame 99 of a timepiece movement 100, and
receive, in the pivot hole 5, a component 98 such as a timepiece staff.

The timepiece component may notably be:
a balance, or
a pallet set, or
an escape wheel, or
a wheel of a finishing gear, such as a center wheel or a minutes wheel or a third wheel or a seconds wheel, or
a wheel of an automatic winding drivetrain.

According to a second use, as illustrated in FIG. 6, the pivot jewel 1 is intended to:
be driven into a timepiece component 98 such as a timepiece staff, and
receive, in the pivot hole 5, a tenon of a frame 99 of a timepiece movement 100 or another timepiece component. The timepiece component 98 or the other timepiece component may notably be a wheel of a finishing gear, such as a center wheel, a minutes wheel or a third wheel or a seconds wheel.

In the first and second uses, with preference, two pivot jewels can be used to guide the timepiece component relative to the frame 99 or relative to another timepiece component.

According to a third use, the pivot jewel 1 is intended to receive a post of a timepiece component 98, such as a lever, in the pivot hole 5. In this use, the pivot jewel is used as a runner and its outer surface 7 is intended to roll on another timepiece component. The outer surface 7 is in this case intended to:
roll in a groove of a drum while the jewel is being manufactured, and
roll on a timepiece component while it is in use, after being manufactured. It is possible for the outer surface 7 to not be cylindrical. It may, for example, be frustoconical overall. Furthermore, it may have a convex profile, or concave profile, or complex profile such as a cam profile, in a plane perpendicular to the axis A1.

More generally, the invention also relates to a timepiece component comprising a hole, notably a cylindrical hole, such as a tube, for example a ceramic tube or a metal tube, or a timepiece component such as a cannon pinion, the pivot hole comprising a surface which has main abrasive-machining striations, notably main polishing striations, which are oriented substantially orthoradially with respect to the axis of the hole.

The invention also relates to a timepiece movement 100 comprising at least one pivot jewel as mentioned above, in particular at least two pivot jewels as mentioned above and/or comprising a timepiece component 98 comprising a pivot jewel 1 as mentioned above, and/or comprising a component as mentioned above.

The invention also relates to a timepiece 200, notably a wristwatch, comprising:
at least one pivot jewel 1 as mentioned above, and/or
a timepiece component as mentioned above, and/or
a timepiece movement 100 as mentioned above.

Measuring the finish of the inner surface 6 of the pivot hole 5 poses a twofold challenge:
successfully accessing the surface 6 of which the finish needs to be measured, this being very difficult given the geometry of the hole, and then
measuring the roughness per se.

It will be seen below how to prepare a jewel in a first phase such that it is then possible to measure the finish of the friction surface 6 in a second phase.

To measure the roughness, it would seem that laser scanning confocal microscopy is particularly advantageous. This because it appears to be suitable for concave surfaces. Laser scanning confocal microscopy makes it possible to precisely measure the surface roughness even at a very low magnification, in compliance with the ISO 25178 (surface-area roughness) and ISO 4287 (linear roughness) standards.

It is preferable in the context of this application to measure the linear roughness and not the areal roughness given the preferential orientation of the roughness. This is because measuring the areal roughness involves taking a mean over the surface area and is relevant when the surface finish is uniform and non-directional, but is less suitable in the present use case which involves the concept of orientation of the roughness. It is therefore appropriate to consider the linear roughness Ra, i.e. the arithmetic mean difference in the profile evaluated.

The preferential orientation of the roughness can be quantified by considering the parameters Str and Std. The parameter Str, sometimes referred to as “isotropy”, is a measure of the evenness of the texture of the surface and takes a unitless value of between 0 and 1, according to the definition in the standard. If the surface has the same characteristics in all directions (isotropic surface), the Str value will be close to 1, whereas a strongly anisotropic or textured surface will have an Str value close to 0.

If the surface is anisotropic (Str value close to 0), it is advantageous to determine the preferential direction of the texture, expressed by the parameter Std. An advantageous tool for this is the polar spectrum, i.e. the integrated Fourier spectrum in polar coordinates. The angle corresponding to the most powerful spectrum corresponds to the main texture direction, and the main direction of the spectrum gives the parameter Std, which is the anticlockwise angle of this main direction from a reference axis of the image. For this, it is therefore important to always orient the images in the same way relative to this reference axis. In addition, it is preferable to take these measurements excluding the edges of the image or of the component, to align the surface so as to remove the effects of shape, and if possible to provide a suitable acquisition pitch and a square image size.

This preferential orientation of the roughness, quantified by the parameters Str and Std, and in particular the preferential direction of the texture expressed by the parameter Std which is the anticlockwise angle of this main direction from a reference axis of the image, corresponds to the orientation of the main striations which determine the roughness of the surface. In other words, it is considered for example that the main striations are oriented substantially orthoradially with respect to the first axis A1 if the anticlockwise angle of the preferential direction of the texture as expressed by the parameter Std is substantially a right angle relative to the first axis A1.

To measure the roughness, it is possible to use, by way of example, an implement provided with a pinhole confocal optical system, such as the VKX-1100 from Keyence. The key parameters are the resolution in the vertical direction and the lateral resolution, and a 50× lens with an aperture of 0.95 used on the aforementioned implement makes it possible to obtain an optimum optical resolution with a sufficient working distance to measure the area of interest of the jewels prepared according to the process described below. The measurement is taken in the central zone of the jewel. The length of the segment is chosen according to the ISO 4287 standard and, for example, 30 different segments are measured successively, each segment being cut into five sub-segments according to the standard to minimize the effect of the shape of the profile.

The measured segments are oriented perpendicularly to the residual polishing striations 61 and/or perpendicularly to the preferential direction of the texture expressed by the parameter Std, so as to obtain a measurement which is characteristic of the roughness. In other words, the measured segments are oriented in the orthoradial direction when the residual machining or polishing scratches are oriented in the axial direction (such as after enlarging), and the measured segments are oriented in the axial direction when the residual machining or polishing scratches 61 are oriented in the orthoradial direction (such as after the polishing process according to the invention described above).

The roughness values obtained can of course vary with the measurement equipment and technique used. The values indicated in this document were all acquired on a laser scanning confocal microscope, at a magnification of 50×, by measuring 30 segments and calculating the roughness Ra.

To take a measurement, it is possible for example to place a half-jewel from the preparation described below into a vice and then focus in on the measurement zone, for example in succession with the various lenses until a clear image is obtained at 50×magnification. An image definition of 2048×1536 pixels can be used with a pitch between segments of 0.10 μm. The segment length can be 65 μm, with 30 lines spaced apart by 2 μm. The roughness is measured in the direction perpendicular to the residual machining or polishing striations. According to the standard, the measurement of the roughness Ra is applicable if and only if the ratio between the standard deviation and the value Ra obtained is strictly less than 0.2.

According to a test carried out on multiple batches of minutes wheel jewels obtained by various processes, it was noted that with a standard enlarging process the residual polishing striations are oriented in the axial direction, and the lines of measurement are consequently oriented in the orthoradial direction. The measured roughness is 25.5±5.0 nm.

With the polishing process according to the invention, the residual polishing striations are oriented in the orthoradial direction, the lines of measurement are oriented in the axial direction, and the measured roughness is 4.0±1.6 nm.

The surface texture is pronounced in both cases, with a comparable Str (isotropy) value close to 0. The isotropy (Str) is however still strictly greater than 0, notably greater than 1%. It is about 20% for the standard enlarging process, versus less than 10%, or even less than 3%, for the process according to the invention. In particular, the process according to the invention makes it possible to obtain a roughness Ra less than 5 nm with a preferential orientation of the texture of 90°+/−0.5 ° in relation to a direction parallel to the axis of the hole and an isotropy greater than 1% and less than 10%, notably less than 3%. The difference is especially evident on the polar spectrum and from the Std value, with a preferential direction of the Std texture=7° and 90.1° for a standard enlarging process and for the process according to the invention, respectively.

The measuring process described above can be used for any type of jewel, including for olive-cut jewels. As mentioned above, the aim of olive cutting is to obtain a rounded pivot-hole profile, and not a straight pivot-hole profile. The edge corners of the hole are softened and a deflection (difference in diameter between the center and the edges of the hole) is measurable and at least 3 μm, more typically at least 5 μm. This deflection value is not specified in designs, because up to now there were no possible ways of measuring this characteristic and the presence of the olive cut is usually observed solely by visual inspection, by way of the oval shape of the reflection in the hole. The value of the deflection will also depend on the diameter and the length of the hole. On the contrary, when measurements of the typical profile are carried out for a jewel according to the present invention, the edge corners of the hole are well defined, and the deflection of the profile of the hole is 0.175 μm. On a measured batch of 40 jewels, the measured deflection was between 0.1 and 0.2 μm, over the 150 μm around the opening of the hole. On the finished jewel, the deflection can be even less, because the length of the hole can be reduced by a possible recessing operation.

The measuring process described above can also be applied to other timepiece components comprising a hole, such as a tube, for example a ceramic tube or a metal tube, or a timepiece component such as a cannon pinion.

The geometry of the jewels makes it very awkward to quantitatively measure the finish of the surface 6 of the pivot hole 5. This surface can only be seen directly by inclining the jewel to a great extent, and it is difficult to take a measurement on an inclined and/or confined surface.

As a result, one embodiment of a phase of preparing a pivot jewel 1 comprises ablating a first part of the pivot jewel 1 including a part of the surface 6 of the pivot hole 5, as well as a part of the outer surface 7 and a part of the volume between the surface 6 of the pivot hole and the outer surface 7, in order to obtain a second part of the pivot jewel 1. This phase of preparing a jewel makes it possible to quickly and reproducibly obtain an element that can be measured with direct and unobstructed access to a zone of the surface 6 to be measured. The illustration in FIG. 1 can constitute a good image of the second jewel part obtained by the preparation process. Specifically, the first part of the pivot jewel can be ablated through the plane passing through the axis A1 of the pivot hole 5 or through a plane parallel to the axis A1 of the pivot hole 5. The aim is to allow direct access to all of a profile of the surface of the pivot hole in the axial direction, notably access for a light beam or laser beam perpendicular or substantially perpendicular to said profile.

In order to obtain access to the pivot hole of a jewel, it might seem that all that would need to be done is to strike the jewel with a tool in order to break it and produce fragments with a pivot-hole surface part intact. However, such a method is very random, is not reproducible and is not suitable for routine checking.

A first method entails a removal of material from one part of the jewel, in particular by abrasion. This method is advantageous in particular when a certain amount of jewels of the same kind must be checked, for example by randomly checking 20 jewels in a batch of 1000 jewels.

The quality of the abraded part is not important because it is not measured. However, it is necessary to ensure that the cutting process does not alter the samples at the hole. A finish-grinding process is for example suitable for being able to quickly prepare the parts by cutting. To position the jewels at the same level and protect the pivot hole, notably in order to avoid the presence of coating resin in the hole if such a resin is used, it is favorable to thread the jewels onto a wire with a diameter very slightly less (for example 10 μm less) than the diameter of the hole, preferably a thread made of nylon or another polymer. It is also possible to use a wire which leaves a clearance greater than 10 μm and to melt the ends in order to plug the holes of the jewels at the ends, thereby ensuring there is no contamination in the hole. It is also possible to use a wire made of metal, for example made of brass, notably for wires of small diameter, for example for diameters less than 0.2 mm. With a metal wire, it is important that the wire is well adjusted relative to the diameter of the hole to prevent the coating resin entering the hole and making the subsequent measurement impossible.

Once the coating is done, it is easy to finish-grind the jewels, for example until they have a difference in height of about the radius of the hole, for example 0.2 mm, between the bottom of the hole and the cut face or the abraded face so that the measuring instrument has easy access to the zone to be measured. The wire can remain in place throughout the step of finish-grinding and be removed only just before the jewels are cleaned and measured. The jewels may be aligned, with the surfaces to be measured at comparable heights, in a configuration which lends itself well to automated measurement. Series of several tens, or even several hundreds of jewels can be measured automatically in this way.

As a result, a sub-step of assembling multiple pivot jewels 1 can be implemented before the ablation.

A second method is particularly suitable for preparing individual jewels, for example unique jewels, notably jewels removed from a blank of a movement. This second method consists in carrying out an ablation by fragmentation.

The procedure allows simple and repeatable cutting of the jewel in order to access the inner walls of timepiece jewels, notably synthetic rubies, with a view to measuring the roughness. The principle is to incise the jewel on one of the upper or lower faces (for example on a non-recessed face) using a diamond tool, such as a diamond chisel or a diamond-tipped tool, in order to initiate a fracture so that the jewel can then be broken by subjecting it to a small impact.

Beforehand, it is ensured that the jewels are in a good clean state before the cutting, for example by optical microscopy. As and when required, dust is removed from the jewels and they are cleaned, for example by washing them in an aqueous phase or in a solvent. The flat face of the jewel is first of all placed facing the operator and is incised with a diamond tool. The incised jewel is then positioned so that a small impact can be applied, for example with a riveting punch made of hard metal placed on a staking tool. A slight blow, for example applied by a horologer's hammer to the rod of the staking tool, makes it possible to break the jewel at the start of the fracture. For this step, the jewels can be held on a fitting or a vice or any other support or means suitable for holding them in place.

The two half-jewels are then recovered, possibly cleaned to remove any residues or particulate matter, and then measured. It should be noted that this method by incising and breaking by way of an impact produces much less particulate matter and debris than traditional wire cutting does. This second method is also repeatable and does not depend on the dexterity of the person performing it.

As an alternative, the jewel or the batch of jewels could also be cut with a saw or a wire. This third method is, however, less favorable given the risk of chips being produced by the cutting in the areas in the vicinity of the surface to be measured.

Thus, generally speaking, a process makes it possible to determine the roughness of the surface 6 of the pivot hole 5 of the pivot jewel 1. This process comprises:
a first step of preparing the pivot jewel 1, comprising ablating a first part of the pivot jewel 1 including a part of the surface 6 of the pivot hole 5 in order to obtain a second part of the pivot jewel 1, and then
a second step of measuring, performed on the surface 6 of the pivot hole 5 located on the second part of the pivot jewel 1.

Logically, the preparation of the jewel, and notably the ablation of a first part of the pivot jewel, does not modify the pivot surface located on the second part of the pivot jewel, such that the roughness measurement obtained is indeed indicative of the surface finish of the pivot hole obtained following the production, notably following the machining and the polishing, of the timepiece component.

The preparation process described above can be used for any type of jewel, including for olive-cut jewels. The preparation process can also be applied to other timepiece components comprising a hole, such as a tube, for example a ceramic tube or a metal tube, or a timepiece component such as a cannon pinion.

The invention also relates to the washing of a timepiece component. Thus, one embodiment of a step of washing the timepiece component 1 and the machining support 20 while the machining support is accommodated in the hole of the timepiece component 1 is described hereinafter in detail.

This step of washing is advantageously implemented in the process for producing the pivot jewel described above and comprising a step of polishing the pivot hole.

However, more generally, a step of washing can be implemented in any process for producing a timepiece component comprising a hole, the process comprising:
a step of machining the hole by abrasion using abrasive particles, notably diamond particles, which are free in relation to a machining support and roll between the surface of the hole to be machined and the machining support accommodated in the hole, and/or using abrasive particles that are able to break off from the machining support.

As a result, the step of washing can also be applied to a process for producing an olive-cut jewel after the step of machining the olive cut.

In these processes, once a jewel 1 has finished passing over the roller 31, some abrasive remains on the machining support and on the jewel. Investigations carried out by the preparation and measurement process have demonstrated that this presence of residual abrasive often poses a problem when the jewels are being taken off of the wire, i.e. when the jewels are removed from the machining support.

This is because the particles of abrasive can become jammed in the pivot hole and cause striations in the axial direction when the jewels are being taken off of the wire or when the component is being removed from the machining support. These scratches or striations can adversely affect the surface finish of the hole, by causing considerable roughness oriented in the axial direction and/or by possibly disrupting the evenness of the rounding of the olive cut, which is undesirable.

If the step of washing is not carried out, scratches in the axial direction are often observed. These scratches can have a low density and a low depth, but can also be very pronounced. In all cases, the roughness is degraded and the effect of the olive cut on the surface finish is partially, or even completely, eliminated. In this instance, this is certainly a degradation that occurs after the olive cutting, and not a residual effect of the enlarging process, because the hole has indeed been brought to its final dimension by the olive cutting with a removal of a considerable amount of material much greater than the depth of the residual enlarging striations. In addition, the scratches observed are superimposed with the characteristic profile of the olive cut, with a symmetrical shape and a deflection of typically a few μm or more.

The addition of the step of washing the machining support and the jewels to eliminate the abrasive before the jewels are taken off of the wire makes it possible to avoid damaging the polished or machined surface. This washing or cleaning can be carried out in various ways, for example in an aqueous medium or a solvent, with or without detergent, with or without ultrasound, or by blowing steam, or by cleaning with water or a solvent. This cleaning can be performed directly on the equipment for cleaning the jewels directly at the run-off of the roller 31, or outside of the equipment once the machining support has been removed. With preference, the washing is performed by using a stream of fluid for carrying away the abrasive particles used during the machining or during the polishing. The fluid may be a washing solution, notably an aqueous solution or an alcoholic solution or an oily solution.

In addition or as an alternative, the step of washing may include immersing the timepiece component 1 and the machining support 20 in a washing solution. The immersing may include emitting ultrasound into the washing solution.

In addition or as an alternative, the step of washing may include spraying a washing solution onto the timepiece component 1 and the machining support 20.

In addition or as an alternative, the step of washing may include blowing a gas or steam.

A washing system 84 can be placed just after the roller. As a result, the step of washing can be carried out directly on the machining machine, notably on the polishing machine on which the step of machining the hole by abrasion was carried out. The washing system 84 can be part of the machining machine 30. This washing system makes it possible to wash or clean the jewels and the machining support immediately after the polishing or the olive cutting or any other machining. The washing system advantageously comprises nozzles 83 and/or channels for spraying a washing fluid, such as a washing solution. With preference, these nozzles and/or these channels are arranged so as to produce jets directed both in the direction of forward movement and in the opposite direction to the forward movement of the jewel on the machining support, and this cleans the jewel firstly on the two sides, and then in the direction of forward movement at the end of the washing system as the jewel exits the washing system. The washing system is advantageously designed so as to form a housing 80 in two parts 81, 82 such that it can be partially opened, for example to fit a new machining support or set the position of the washing system in relation to the machining support and to the rest of the machine. As a result, the washing system 84 can take the form of a housing 80 as shown in FIG. 7. The assembly made up of the timepiece component 1 and the machining support 20 can pass all the way through this housing 80. The housing 80 thus has a passage for the machining support.

In an alternative, the step of washing can be carried out after removal of the assembly made up of:
the timepiece component 1, and
the machining support 20
   from the machining machine on which the step of machining the hole by abrasion was carried out. In such a case, the assembly made up of the timepiece component 1 and the machining support 20 are removed from the machining machine, then the assembly made up of the timepiece component 1 and the machining support 20 is washed, and then the timepiece component 1 is removed or separated from the machining support 20, in particular the machining support 20 is taken out of the hole of the timepiece component 1.

More generally than what has been described above, a process for producing a timepiece component 1 may comprise:
a step of machining the hole 5 by abrasion using abrasive particles 21 which are free in relation to a machining support 20 and roll between the surface 6 of the hole to be machined and the machining support 20 accommodated in the hole, and/or using abrasive particles that are able to break off from the machining support, then
a step of washing the timepiece component 1 and the machining support 20 while the machining support is accommodated in the hole, and then
a step of removing the machining support from the hole.

1. A process for producing a timepiece component comprising a hole, the process comprising:
machining the hole by abrasion (i) using abrasive particles, the abrasive particles being free relative to a machining support, the abrasive particles rolling between a surface of the hole to be machined and the machining support accommodated in the hole, and/or (ii) using abrasive particles that are able to break off from the machining support, then
washing the timepiece component and the machining support while the machining support is accommodated in the hole, and then
removing the machining support from the hole.

2. The process according to claim 1, wherein the washing comprises using a washing solution.

3. The process according to claim 2, wherein the washing includes immersing the timepiece component and the machining support in the washing solution.

4. The process according to claim 3, wherein the immersing includes emitting ultrasound into the washing solution.

5. The process according to claim 1, wherein the washing includes spraying a washing solution onto the timepiece component and the machining support.

6. The production process according to claim 1, wherein the washing includes blowing a gas or steam.

7. The process according to claim 1, wherein the washing is carried out on a machining machine on which the machining of the hole by abrasion was carried out.

8. The process according to claim 1, wherein the washing is carried out after removal of an assembly comprising:
the timepiece component, and
the machining support,
from a machining machine on which the machining of the hole by abrasion was carried out.

9. The process according to claim 8, wherein the washing is implemented in a housing, the assembly comprising the timepiece component and the machining support passing all the way through the housing.

10. A washing system comprising hardware for implementing the washing of a timepiece component while a machining support is accommodated in a hole of a timepiece component, wherein the washing system includes:
a housing formed overall by two parts which are movable with respect to one another and/or have a passage for the machining support, and
nozzles and/or channels for spraying a washing solution.

11. A machining system comprising hardware for implementing the process according to claim 1.

12. A timepiece component obtained by implementing the process according to claim 1.

13. A timepiece movement comprising a timepiece component according to claim 12.

14. A timepiece comprising a timepiece movement according to claim 13.

15. The process according to claim 1, wherein the timepiece component is a pivot jewel.

16. The process according to claim 1, wherein the abrasive particles are diamond particles.

17. The process according to claim 2, wherein the washing solution is an aqueous solution or an alcoholic solution or an oily solution.

18. The process according to claim 17, wherein the washing includes immersing the timepiece component and the machining support in the washing solution.

19. The process according to claim 18, wherein the immersing includes emitting ultrasound into the washing solution.

20. The process according to claim 2, wherein the washing includes spraying the washing solution onto the timepiece component and the machining support.
